(19) United States
(12) Patent Application Publication
(10) Pub. No.: US 2011/0303298 A1
(43) Pub. Date: Dec. 15, 2011

(54) METHOD FOR CLOSING A MOBILE CRADLE ELEMENT

(75) Inventor: Marc Gerome, Le Havre (FR)

(73) Assignee: AIRCELLE, Gonfreville L'Orcher (FR)

(21) Appl. No.: 13/202,695

(22) PCT Filed: Feb. 8, 2010
(86) PCT No.: PCT/FR10/00091

§ 371 Date: Aug. 22, 2011

(30) Foreign Application Priority Data
Feb. 20, 2009 (FR) 09/00777

(51) Int. Cl. F02K 99/00; E05F 15/06

(52) U.S. Cl. 137/1; 49/506; 137/15.1

(57) ABSTRACT

The invention relates to a method for closing a mobile element (1) actuated by at least one actuator (2) such as a cylinder equipped with a terminal backlash device (4), said cover also being associated with at least one locking means, the closing method comprising the following steps which aim:—by means of the cylinder, to drive the mobile cover to close on a portion of the travel thereof, until said cover reaches the proximity of an area with closing forces, the distance remaining to be travelled being less than the available backlash of the cylinder;—by means of the locking means, to complete the travel of the mobile cover until said cover closes, the cylinder being located in the backlash area thereof.

### TECHNICAL FIELD

The present invention relates to a device for closing a mobile cowl of a turbojet engine nacelle, and a nacelle equipped with such a closing device.

### BACKGROUND

As is known in itself, an aircraft engine nacelle comprises at least one cowl able to move between a service position, in which said cowl covers an element or part of the nacelle and/or the turbojet engine, and a maintenance position, in which this cowl is moved away from the nacelle and exposes said element or said part, thereby allowing a technician to work inside the nacelle or on the turbojet engine, in particular for maintenance operations.

Such cowls are in particular known arranged at a middle section of the nacelle surrounding a fan of the turbojet engine and generally opening in a butterfly.

Given the high weight of such a cowl, in particular on large nacelles like those used on the Airbus A380, it is essential to provide assistance means for opening this cowl.

These assistance means, frequently designated by the English term PCOS (“Powered Cowl Operating System”), generally comprise at least one hydraulic or electric cylinder, which can be controlled so as to open or close the cowl.

As known in itself, such a cylinder has, at its end cooperating with the cowl, a “free play” device, allowing a small additional excursion of the end of this cylinder for a given extension of the cylinder.

The function of this free play is on the one hand to avoid transmitting compression/traction forces to the cylinder during flight, when the cowl undergoes deformations related to specific pressure profiles, and on the other hand to allow easy manual closing of the cowl at the end of maintenance operations, despite friction created by the tolerances of the different pieces cooperating with each other.

A strut or guard is also generally provided so as to lock the cowl in the open position and ease the weight of this cowl on the cylinder. This strut is placed manually by the technician, and removed by the technician just before the cowl is closed.

One therefore understands that during closing, the cylinder is assisted by the weight of the mobile cowl.

In the case of a translatable mobile cowl in a substantially longitudinal direction of the nacelle, such as, for example, a mobile cowl of an air intake of the nacelle, this closing assistance via the weight of the cowl does not exist.

A closing phase of a mobile cowl comprises two phases, i.e. a closing phase of the cowl and a final locking phase of the cowl using associated locking means.

During the closing phase, or about 98% of the travel of the cylinder, relatively low forces, typically around a hundred daN, are necessary to translate the mobile cowl. However, during the locking phase, or approximately over the last two percent of the travel of the cylinder, much more substantial forces, typically about 800 daN, are needed to be able to compress the closing joints, for example.

Thus, the cylinder(s) must be dimensioned to be able to provide the final maximum power whereas this power is only necessary over a small portion of the travel of the cylinder(s).

The assembly then becomes heavier, which has an impact on the aeronautic performance.

### BRIEF SUMMARY

The present invention in particular aims to resolve these drawbacks and to that end comprises a method of closing a mobile element actuated by at least one cylinder-type actuator equipped with a terminal free play device, said cowl also being associated with at least one locking means, the closing method comprising the following steps aiming to:
with the assistance of the cylinder, drive the closably movable cowl over part of its travel until it arrives near a closing force zone, the remaining distance to travel being smaller than the available free play of the cylinder.
with the assistance of the locking means, completing the travel of the mobile cowl until it closes, the cylinder being located in its free play zone.

Thus, by using the free play of the cylinder to finalize the closing of the mobile element using the locking means, it is possible to reduce the size of the cylinder, and therefore its weight and bulk, since it is no longer the jack that must be able to provide the final forces necessary for closing, such as the joint compression forces.

Using the numerical example provided above, the cylinder can therefore be sized for the several hundred daN needed to move the cowl over the majority of its travel, the 800 daN necessary for final closing being provided by the locking means.

In fact, the locking means must generally perform a pre-load phase requiring about 400 daN per bolt and are sized to be able to supply this effort. A mobile nacelle cowl typically comprising four bolts, 1600 daN is therefore available via the bolts. It therefore appeared that the bolts were capable of providing the forces necessary for the final closing phase of the cowl. Using the bolts also to perform this final phase, it is therefore no longer necessary to oversize the cylinder.

Preferably, the method comprises an additional step of locking the cowl by the bolts.

Advantageously, the mobile element is translatable.

Preferably, the mobile element is a cowl of a turbojet engine nacelle.

Also preferably, the mobile cowl is a maintenance cowl of an air intake structure of the nacelle.

Advantageously, the actuator is an electromechanical actuator.

The present invention also relates to a turbojet engine nacelle comprising at least one mobile cowl equipped with at least one actuator comprising a free play device and associated with at least one locking means of said cowl, characterized in that the locking means is able to drive the mobile cowl to close over a final part of its closing travel using a method according to the invention.

### BRIEF DESCRIPTION OF THE DRAWINGS

Other features and advantages of the present invention will appear in light of the following description, and upon examining the appended figures, in which:

FIGS. 1 to 4 show the steps of a first embodiment of a method according to the invention for closing a mobile nacelle cowl with assisting outside forces.

FIGS. 5 to 8 show the steps of a second embodiment of a method according to the invention for closing a mobile nacelle cowl with resistant outside forces.

### DETAILED DESCRIPTION

A turbojet engine nacelle (not shown) forms a tubular housing for a turbojet engine whereof it serves to channels the flows of air it generates by defining inside and outside aerodynamic lines needed to obtain optimal performance.

It also houses different components needed for the operation of the turbojet engine as well as related systems such as a thrust reverser.

More specifically, a nacelle has a structure comprising a front section forming an air intake, a middle section surrounding a fan and a rear section surrounding the turbojet engine and able to house a thrust reverser system.

The nacelle structure also comprises one or more mobile cowls intended for maintenance operations and allowing access to the inside of the nacelle.

In particular, the front section can be equipped with at least one such mobile cowl 1 formed from an outer panel and incorporating an air intake lip, said cowl 1 being mounted translatably along a substantially longitudinal direction of the nacelle.

The mobile cowl 1 can be translated by one or more cylinders 2, preferably electromechanical, between a closing position in which the continuity of the aerodynamic lines is ensured and an opening position in which it allows access to the inside of the air intake section of the nacelle.

Moreover, said mobile cowl 1 is associated with a locking means (not visible) able to ensure maintenance thereof in a closed position and its junction with the median section.

To implement the method according to the invention, the cylinders 2 are equipped with free play devices 4 forming a part freely translatable relative to the cylinder 2. This free play device 4 can be associated with an elastic return means 5 keeping it retracted relative to the body of the cylinder 2. Of course, the default retraction or extension position of the device depends on the assembly direction of the cylinder and the direction of translation of the cowl 1 and the retraction mode is given here as an example.

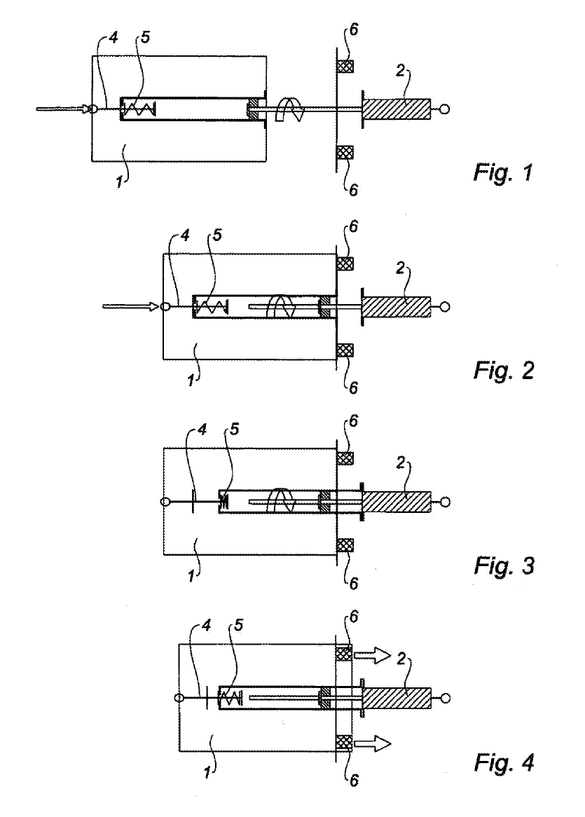

FIGS. 1 to 4 show a first alternative of the closing method according to the invention in the event the mobile cowl 1 is subjected to assisting forces (e.g. wind).

The mobile cowl 1 is first (FIG. 1) closed using cylinders 2 over approximately 98% of its closing travel. The assisting forces push the free play device 4 into the retracted position relative to the body of the cylinder 2.

The cowl then arrives (FIG. 2) in a joint recentering and compression zone 6 in which the forces necessary to close it are greater than those the cylinder 2 can develop.

As a result, the cylinder finishes (FIG. 3) its retraction alone over the remaining 2% while the free play device 4 extends relative to the cylinder. The cylinder is in fact capable of compressing the elastic return means 5, but incapable of overcoming the recentering and compression forces. The cowl 1 therefore remains immobile.

Of course, in the case of a cowl 1 without a joint 6, only the cylinders will be sufficient.

The end of closing (FIG. 4) is done using locking means. The free play device therefore returns towards a position in which it is at least partially retracted.

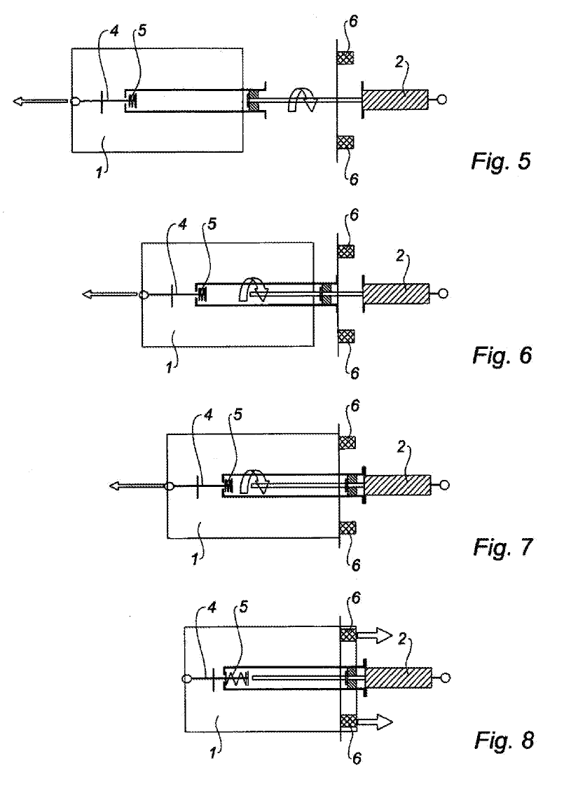

FIGS. 5 to 8 show a second alternative embodiment of the closing method according to the invention in the case where the mobile cowl 1 is subjected to resistive forces (e.g. friction).

The mobile cowl 1 is first (FIG. 5) closed using cylinders 2 over approximately 98% of its closing travel as before. The resistive forces are such that the free play device 4 is in the extended position relative to the body of the cylinder 2, the latter compressing the spring 5.

The cowl then arrives (FIG. 6) in the automatic closing zone of the cowl in which the cowl no longer sees the resistive forces due to wind, for example, and therefore adheres to the joints 6 in which the forces necessary for its closing are greater than those the cylinder 2 may develop.

As a result, the cylinder alone ends (FIG. 7) its retraction over the remaining 2% and the free play device 4 remains extended relative to the cylinder 2.

The end of closing (FIG. 8) is done using locking means. The free play device therefore returns to an at least partially retracted position.

Of course, the present invention is in no way limited to the embodiments described and illustrated, provided solely as examples.

1. A method of closing a mobile element actuated by at least one cylinder-type actuator equipped with a terminal free play device, said cowl also being associated with at least one locking means, the closing method comprising:
with the assistance of the cylinder, driving the closably movable cowl over part of its travel until it arrives near a closing force zone, a remaining distance to travel being smaller than an available free play of the cylinder.
with the assistance of the locking means, completing the travel of the mobile cowl until it closes, the cylinder being located in a free play zone.

2. The closing method according to claim 1, further comprising locking the mobile element using the bolts.

3. The closing method according to claim 1, wherein the mobile element is translationally mobile.

4. The closing method according to claim 1, wherein the mobile element is a cowl of a turbojet engine nacelle.

5. The closing method according to claim 4, wherein the mobile cowl is a maintenance cowl of an air intake structure of the nacelle.

6. The closing method according to claim 1, wherein the actuator is an electromechanical actuator.

7. A turbojet engine nacelle comprising at least one mobile cowl equipped with at least one actuator comprising a free play device and associated with at least one locking means of said cowl, wherein the locking means is able to drive the mobile cowl to close over a final part of its closing travel using a method according to claim 1.
